(19) United States
(12) Patent Application Publication
(10) Pub. No.: US 2020/0050441 A1
(43) Pub. Date: Feb. 13, 2020

(54) SYSTEM AND METHOD FOR DATA PROCESSING OF ON-BOARD-UNIT

(71) Applicant: Hua-chuang Automobile Information Technical Center Co., Ltd., New Taipei City (TW)

(72) Inventors: Tien-Yu KU, New Taipei City (TW); Ming-Hung CHIANG, New Taipei City (TW); Chao-Chun CHENG, New Taipei City (TW)

(21) Appl. No.: 16/158,812

(22) Filed: Oct. 12, 2018

(30) Foreign Application Priority Data
Aug. 10, 2018 (TW) 107128088

(51) Int. Cl. G06F 8/65; G06F 9/4401; B60R 11/02

(52) U.S. Cl. CPC G06F 8/65; B60R 2011/0005; B60R 11/0258; G06F 9/4406

(57) ABSTRACT

An on-board unit is adopted to perform a method for data processing of the on-board-unit. The method includes steps for establishing an application communication channel with a handheld device via a pairing procedure; establishing communication with a vehicle parts controller, wherein the vehicle parts controller is configured for receiving a control request for a parts control operation; enabling at least one application service in response to a service request; receiving a command package, and comparing the command package with the service request; when the command package matches the service request, providing the application service via the application communication channel; or when the command package does not match the service request, further comparing the command package with the control request; and if the command package matches the service request, transmitting the control request to the vehicle parts controller to perform the parts control operation according to the control request.

### CROSS-REFERENCE TO RELATED APPLICATION

This non-provisional application claims priority under 35 U.S.C. § 119(a) to Patent Application No. 107128088 filed in Taiwan, R.O.C. on Aug. 10, 2018, the entire contents of which are hereby incorporated by reference.

### BACKGROUND

### Technical Field

The present disclosure relates to an on-board unit of a vehicle, and in particular, to an on-board information system and a method for data processing of the on-board-unit.

### Related Art

An on-board unit (OBU) of a vehicle is an embedded computer and electrically connected to vehicle parts, to obtain vehicle parts status information, and further get into control of the vehicle parts. By means of updating of software, the OBU may also provide additional information services.

By using wireless communication protocols such as the Bluetooth protocol, the OBU is able to connect to a handheld device (such as a smartphone), so that data exchange or voice transmission may be executed between the handheld device and the OBU. A common application manner is using the OBU as a hands-free car kit of a mobile phone. Another application manner is that the OBU and the handheld device push data to each other.

However, a vehicle part generally adopts a wired communication protocol, especially a controller area network (CAN) protocol. The handheld device cannot be connected to a vehicle part by using a wireless communication protocol, and is also short of an interface for a wired communication connection with vehicle parts. Therefore, obtaining of a vehicle part status information or manual control of a vehicle part still requires the OBU or a dedicated control panel, so that a communication between the handheld device and a vehicle is still limited.

### SUMMARY

In view of the foregoing problem, the present disclosure provides an on-board information system of an on-board unit and a method for data processing of the on-board-unit for expanding a connection between a handheld device and a vehicle.

The present disclosure provides an on-board information system of an on-board unit, including a vehicle parts controller and an on-board unit (OBU). The vehicle parts controller is configured for receiving a control request, and executing a parts control operation. The on-board unit includes an application programming interface (API), a control request transmitter, an application executing module, and an application programming interface server (API server). The application programming interface is configured for establishing an application communication channel via a pairing procedure, and receiving a command package via the application communication channel; the control request transmitter is configured for establishing communication with the vehicle parts controller; the application executing module provides an application service, wherein the application service is in response to at least one service request; and the API server is configured for receiving the command package through the application programming interface, and comparing the command package with the service request.

When the command package matches the service request, the API server drives, according to the service request, the application executing module to execute the application service, and provides the application service via the application communication channel. When the command package does not match the service request, the API server compares the command package with the control request and when the command package matches the control request, the API server transmits the control request to the vehicle parts controller for executing the parts control operation according to the control request.

The method for data processing of the on-board-unit in the present disclosure includes: establishing an application communication channel via a pairing procedure; establishing communication with a vehicle parts controller, wherein the vehicle parts controller is configured for receiving a control request and executing a parts control operation; enabling at least one application service, wherein the application service is in response to a service request; receiving a command package, and comparing the command package with the service request; when the command package matches the service request, providing the application service via the application communication channel; when the command package does not match the service request, comparing the command package with the control request, and when the command package conforms to the control request, transmitting the control request to the vehicle parts controller, to execute the parts control operation according to the control request.

In the present disclosure, by means of the connection between the API server and the control request transmitter, a technical problem that the handheld device cannot be connected to a vehicle is solved, so that the handheld device can more widely communicate with the vehicle to increase application manners of the handheld device.

### BRIEF DESCRIPTION OF THE DRAWINGS

The present disclosure will become more fully understood from the detailed description given herein below for illustration only, and thus are not limitative of the present disclosure, and where:

FIG. 1 is a schematic block diagram according to an embodiment of the present disclosure.

FIG. 2 is a schematic block diagram according to the embodiment of the present disclosure in which a handheld device is connected to an application programming interface server.

FIG. 3 and FIG. 4 are method flowcharts according to the embodiment of the present disclosure.

FIG. 5 is a schematic diagram according to the embodiment of the present disclosure in which the system and method are applied to multiple handheld devices.

### DETAILED DESCRIPTION

The terms “module”, “server”, and “service” used in the following description refer to an application specific integrated circuit (ASIC), an electronic circuit, a microprocessor, a chip for executing one or more software or firmware programs, and a circuit design. Modules are configured to execute various algorithms, transformation, and/or logical processing to generate one or more signals. When the module, the server, and the service are implemented as software, the module may be used as readable program code of chips and circuit designs to be executed and embodied in a memory by means of program code.

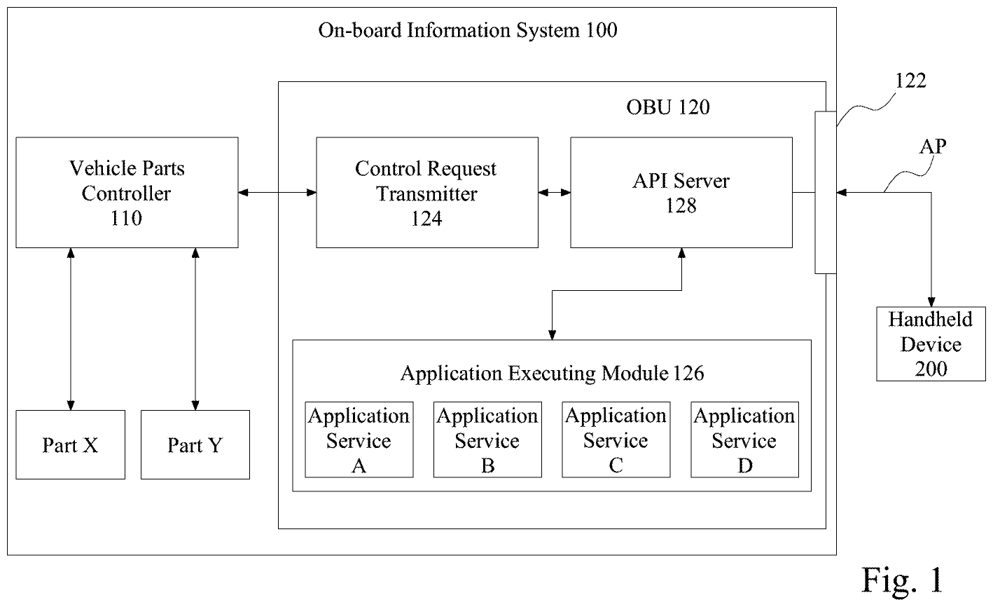

Referring to FIG. 1, an on-board information system 100 according to an embodiment of the present disclosure is configured to be disposed on a vehicle. The on-board information system 100 at least includes at least a vehicle parts controller 110 and an on-board unit 120 (OBU 120). The present disclosure further provides a method for data processing of the OBU 120, to process information exchange on the vehicle. The method may be executed by using the OBU 120, but the present disclosure is not limited thereto.

As shown in FIG. 1, the vehicle parts controller 110 is configured for receiving a control request, executing a parts control operation, and controlling different vehicle parts X and Y. An specific implementation of the vehicle parts controller 110 is an automobile electronic control unit (ECU), configured to control vehicle parts X and Y such as a power device (for example an engine), a transmission device (for example a car transmission system), and an on-board electronic device (for example a car audio system, a speed detection module, or an on-board air conditioner) of the vehicle according to the control request, such as an accelerator signal, a speed change signal, or an on-board electronic device control signal, and the ECU may detect or receive parts operation statuses of the vehicle parts X and Y.

As shown in FIG. 1, the on-board unit 120 includes an application programming interface 122 (API 122), a control request transmitter 124, an application executing module 126, and an application programming interface server 128 (API server 128).

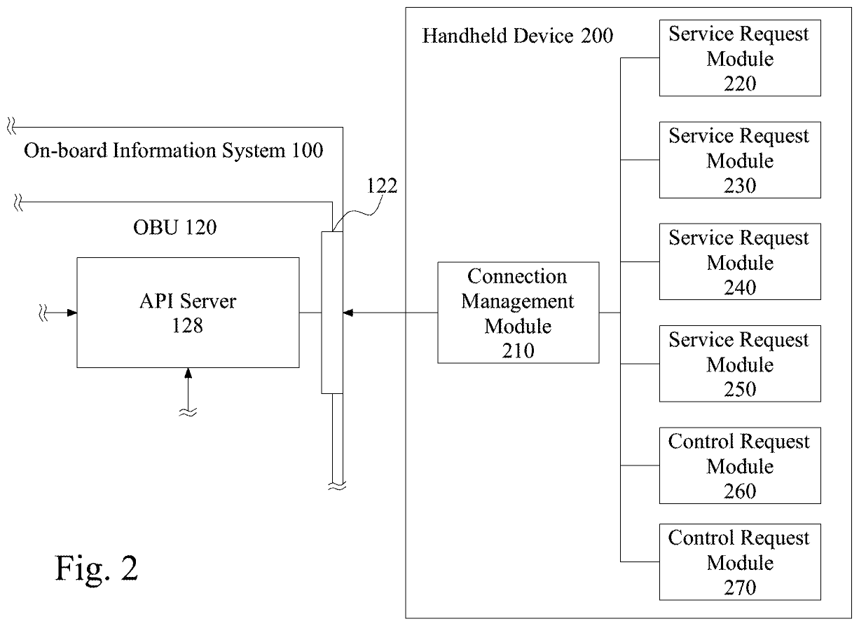

As shown in FIG. 2, the application programming interface 122 and the control request transmitter 124 are both communication interfaces, and adopt different communication protocols according to required communications objects. Generally, the API 122 adopts a wireless communications interface for communicating with the handheld device 200. More specifically, the API 122 can be a Bluetooth communications interface with a point-to-point (P2P) communication function, and provide a communication channel based on the Bluetooth Serial Port Profile (Bluetooth SPP). The control request transmitter 124 can be a wired communications interface, to ensure reliability of a communication connection.

As shown in FIG. 1, the API 122 is paired with the handheld device 200 via a pairing procedure, for establishing an application program communication channel AP connected to the handheld device 200. The handheld device 200 includes, but is not limited to, a smartphone, a tablet computer, and a wearable mobile device.

As shown in FIG. 2, the handheld device 200 includes a connection management module 210 and multiple application modules. The multiple application modules include service request modules 220, 230, 240, and 250 and control request modules 260 and 270. The connection management module 210 is configured to communicate with the API 122 of the OBU 120 via the application communication channel AP, to be used as a communication layer for connecting the service request modules 220, 230, 240, and 250 and the control request modules 260 and 270 to the OBU 120. The service request modules 220, 230, 240, and 250 may execute a default function, and respectively send service requests for executing application services A, B, C, and D. The service requests are encoded as command packages by using the connection management module 210 and are sent. For example, the service request module 220 is configured to send a service request for executing the application service A, the service request module 230 is configured to send a service request for executing the application service B, the service request module 240 is configured to send a service request for executing the application service C, and the service request module 240 is configured to send a service request for executing the application service D. The service request modules 220, 230, 240, and 250, and the application services A, B, C, and D are examples. There may be any quantity of service request modules, and each service request module is configured for an application service. That is, each service request module has one corresponding application service, and may send a service request for executing the application service. Each of the service request modules 220, 230, 240, and 250 may be separately implemented by executing individual application software, or same application software may be executed to implement the different service request modules 220, 230, 240, and 250.

The control request module 260 and 270 also respectively execute pre-determined functions of the control request module 260 and 270, and respectively send control requests for controlling vehicle parts X and Y of the vehicle. For example, the control request module 260 executes a pre-determined function, and sends a control request for controlling the vehicle part X of the vehicle, and the control request module 270 executes a pre-determined function, and sends a control request for controlling the vehicle part Y of the vehicle. A control request is encoded as a command package by using the connection management module 210 and is sent via the application communication channel AP. The control request modules 260 and 270 and the vehicle parts X and Y are examples. There may be any quantity of control request modules, a control request module separately corresponds to a vehicle part, and each vehicle part may respond to multiple different control requests. Each control request module has a corresponding vehicle part, and may send various control requests for controlling the vehicle part. The control request modules 260 and 270 may be separately implemented by executing individual application software, or same application software may be executed to implement the different control request modules 260 and 270.

As shown in FIG. 1, the API 122 receives, via the application communication channel AP, the command package sent by the handheld device 200, and returns response information. The control request transmitter 124 is configured for establishing communication with the vehicle parts controller 110, so that the vehicle parts controller 110 and the OBU 120 may transmit data packages to each other. The vehicle parts controller 110 and the vehicle parts X and Y are generally in a wired communication connection, to ensure reliability of the communication connection, and a common communication protocol on the vehicle is a controller area network (CAN), but this is not limited.

As shown in FIG. 1, a specific embodiment of the OBU 120 is an embedded computer. The application executing module 126 and the API server 128 are functional modules provided after program code stored in a memory is loaded by a processor of the embedded computer. Certainly, the application executing module 126 and the API server 128 may also be a chip or chipset for executing a dedicated firmware instruction.

As shown in FIG. 1, the application executing module 126 provides one or more application services A, B, C, and D, and the application services A, B, C, and D, are displayed in a widget on a touch control display. For example, a widget corresponding to the application services A, B, C, and D is displayed on a touch control display panel. Each of the application services A, B, C, and D is in response to at least one service request for executing a corresponding task according to content of the service request. In at least one example, the service request includes displaying a command of specified information and content of the specified information. For example, it is required to display an electricity quantity icon and an electricity quantity value of the handheld device 200. The API server 128 is configured to parse the command package, to compare the content of the command package with the service request.

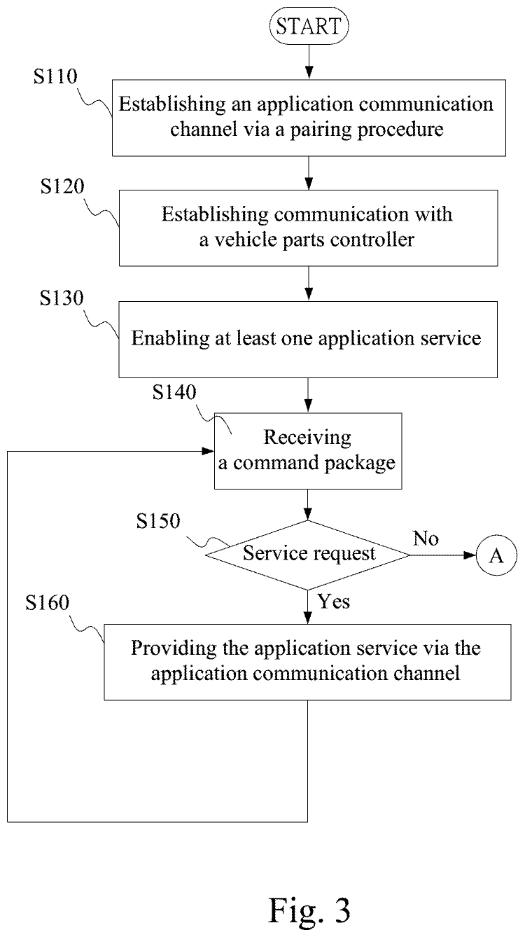

Referring to FIG. 3, the method for data processing of the OBU 120 includes the following steps.

First, the API 122 of the OBU 120 is paired with the handheld device 200 via a pairing procedure, and establishes an application communication channel AP, as shown in step S110. This step is mainly to establish a P2P dedicated communication link between the OBU 120 and the handheld device 200 through the API 122.

In addition or following step S110, the OBU 120 establishes communication with the vehicle parts controller 110 via the control request transmitter 124, as shown in step S120. The specific implementation of the vehicle parts controller 110 is described above. The vehicle parts controller 110 is configured for receiving a control request, and executing control tasks of the vehicle parts X and Y of the vehicle according to the control request.

In addition or following step S120, the OBU 120 starts one or more application services A, B, C, and D, and each of the application services A, B, C, and D is in response to a corresponding service request, as shown in step S130. As shown in FIG. 2, the service request is generated by the service request modules 220, 230, 240, and 250 according to an operation by a user on the handheld device 200, and each of the service request modules 220, 230, 240, and 250 corresponds to one of the application services A, B, C, and D. For example, the service request module 220 corresponds to the application service A, the service request module 230 corresponds to the application service B, the service request module 240 corresponds to the application service C, and the service request module 250 corresponds to the application service D.

The handheld device 200 generates and sends a command package according to an executed application module, and the command package may include either of a service request or a control request. The OBU 120 receives the command package sent by the handheld device 200, and the application executing module 126 compares the command package with the service request, as shown in step S140 and step S150.

The content of the command package may be listed in a table, for example, the following Table 1:

TABLE 1

| | | | Platform | |
|---|---|---|---|---|
| Category | Task | Interface Type | Identifier | Input Value |
| Application Service A | caller ID | caller ID | Vehicle Model A | TRUE/FALSE |
| | display | display reminder | | |
| | | Enabled | | |
| Application Service B | Automatic | Switch | Vehicle Model A | TRUE/FALSE |
| | answer | | | |
| | setting | | | |
| Application Service C | Display | Display | Not limited | TRUE/FALSE |
| | mobile | electricity | | |
| | phone | quantity icon | | |
| | electricity | and electricity | | |
| | | quantity value | | |
| Application Service D | Mobile | On/off icon | Not limited | TRUE/FALSET |
| | phone | | | |
| | screen | | | |
| | switch | | | |
| Vehicle Part X | Audio | Audio volume | Not limited | + or − |
| | volume | display | | |
| | setting | | | |
| Vehicle Part X | Audio | Equalizer | Not limited | + or − |
| | equalizer | mode display | | |
| | mode | | | |
| | setting | | | |
| Vehicle Part Y | display | Speed value | Vehicle Model B | TRUE/FALSE |
| | vehicle | | | |
| | speed | | | |

The category field specifies corresponding application services A, B, C, and D, and the task field is functions of the application services A, B, C, and D, such as a field required to display information when the information is being displayed. The Interface Type is related to the functions, such as on/off switching or value input, for determining whether the input value format is correct. The input value is related to a task to be executed. For example, when on/off switching of a particular function is executed, the input value is TRUE/FALES, and when a particular function value is adjusted, the input value is a number. In the horizontal fields, text instructions and input values may be written sequentially by using a script such as the JSON (Java Script Object Notation) to form command packages. Certainly, the command package also includes information required for establishing P2P communication, such as a device identifier or a connection authorization code.

The application executing module 126 receives a command package, parses the field of the package content, and compares the content with the list of Table 1. For example, when the package content of the command package is sequentially application service A, caller ID display, caller ID display reminder enabled, Vehicle model A, and TRUE, it may be determined that the command package includes a service request from the handheld device 200.

If a package content header (category) of the command package does not have the corresponding application services A, B, C, and D, or the complete package content is not in the list, it is determined that the command package does not include a correct service request.

Situations in which the command package does not include a correct service request include: the package format is incorrect (the command package is unrelated to the service request), the corresponding application service is not enabled on this vehicle model, the task is incorrect, it is not applicable to a current vehicle, the input value is incorrect, and the like.

As shown in FIG. 3, when the command package matches the service request, for example, conforms to one of the field at the row 1 to the field at the row 4 in Table 1, the application executing module 126 executes the application services A, B, C, and D according to the service request, and provides the application services A, B, C, and D to the API 122 via the application communication channel AP, as shown in step S160.

The field at the row 1 in Table 1 is used as an example. When a smartphone used as the handheld device 200 receives a call, a caller ID display program (the service request module 220) of the smartphone sends a service request for call ID display to the application executing module 126 by using the connection management module 210. The application executing module 126 starts an application service A of caller ID display, and then drives a touch control display to display an incoming call. The handheld device 200 continuously sends different service requests, including a caller ID and a hands-free phone connection request. The service requests may be generated by another service request modules 230, and require other application services. In this case, the touch control display continuously displays the caller ID and a message about whether to answer with a hands-free mode. The service requests are related to a call function of the smartphone. For example, the application service A involves whether to enable the caller ID display of the smartphone, and the application service B involves whether to enable an automatic answer function of the hands-free mode of the smartphone.

The application executing module 126 also sends a handheld device control request via the application communication channel AP, to obtain a connection control authentication of the handheld device 200, and receives a handheld device control response via the application communication channel AP. For example, in the foregoing examples, if a user uses the handheld device 200 to start the application service B to enable automatic answer of the hands-free mode, the application executing module 126 is in response to a service request for the automatic answer of the hands-free mode, to obtain the connection control authentication of the handheld device 200, and bridged the phone call of the handheld device 200 to the application executing module 126, and then the application executing module 126 drives necessary hardware to execute a hands-free mode task.

Another case is that the OBU 120 displays particular information on the handheld device 200, such as an electricity quantity icon and an electricity quantity value of the handheld device 200. In this case, after the user first sends a service request package in the field at the row 3 in Table 1 by using the application program C (the input value is TRUE), a manner in which the application executing module 126 provides the application service C includes sending an information request of specified information to the handheld device 200 via the application communication channel AP, to require the handheld device 200 to transmit back the specified information (the electricity quantity icon and the electricity quantity value of the handheld device 200), so that the application executing module 126 receives a response to the specified information via the application communication channel AP, to display the specified information. In addition, to continuously update the electricity quantity icon and the electricity quantity value of the handheld device 200, the manner for providing the application service C further includes: the application service C regularly and repeatedly sends information request, and receives the response with regard to the specified information (the updated electricity quantity icon and electricity quantity value of the handheld device 200), to update the displayed specified information. Alternatively, the handheld device 200 directly and periodically sends the service request and makes the service request include the specified information, so that the application executing module 126 directly responds, to display and continuously update the specified information. The application executing module 126 may also obtain the connection control authentication of the handheld device 200 for operate the handheld device 200 by using the OBU 120. The user uses the handheld device 200 to start the application service D, and the application executing module 126 is in response to a service request for mobile phone screen switch, to obtain the connection control authentication of the handheld device 200, and displays an on/off icon by using the touch control display of the OBU 120, so that the user may turn on/off a screen of the handheld device 200 by using the touch control display of the OBU 120.

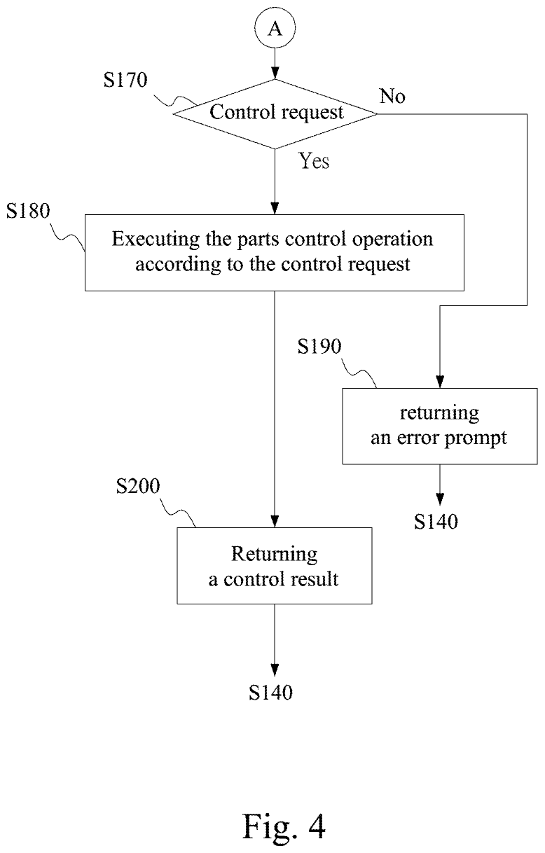

As shown in FIG. 3 and FIG. 4, when the command package does not match the service request, the application executing module 126 further compares the command package with the control request, as shown in step S170. If the command package matches the control request, for example, matches the fields at the row 5 to the row 7 in Table 1, the application executing module 126 transmits the control request to the vehicle parts controller 110 by using the control request transmitter 124, so that the vehicle parts controller 110 executes a parts control operation according to the control request, as shown in step S180.

If the command package does not match the control request either, the application executing module 126 returns an error prompt, for example, that the instruction is not in the list of the table, and the application communication channel AP returns the error prompt to the handheld device 200, as shown in step S190.

Back to step S180, after executing the parts control operation according to the control request, the vehicle parts controller 110 returns a control result, and the control result is output to the handheld device 200 by using the control request transmitter 124, the API server 128, the API 122, and the application communication channel AP, as shown in step S200.

The parts control operation includes various types of operation, one of which is shown in the field at the row 5 in Table 1. The category field specifies a corresponding vehicle part X, and the vehicle part X may be an on-board audio device. The task field is a task to be executed according to the control request, for example, audio volume setting. The Interface Type is related to a function, such as the current audio volume display, and is for determining whether the input value format is correct. The input value is related to the task to be executed. For example, when the audio volume setting is executed, the input value is raising the volume (+) and reducing the volume (−). According to the control request, text instructions and input values may also be written sequentially by using a script such as the JSON language, to become command packages. Certainly, the command package also includes information required for establishing P2P communication, such as a device identifier or a connection authorization code. The vehicle part X used as the automobile audio device has another function setting and a related control request may still be generated by the corresponding control request module 260. For example, when an equalizer mode needs to be selected, a control request in the field at the row 6 in Table 1 may be sent, to switch between different equalizer modes by using the input value +/−.

The parts control operation may be merely obtaining a parts operation status, to provide the parts operation status to the handheld device 200. For example, when the user of the handheld device 200 requires a current vehicle speed, the vehicle parts controller 110 drives a related vehicle speed detection mechanism, to detect the vehicle speed as the parts operation status, and output the parts operation status as a control result. For example, the vehicle part Y is used as a vehicle speed detection module. The control request module 270 may send the command package in the field at the row 7 in Table 1, to trigger, by using the input value TRUE, the vehicle part Y to respond, and transmit back the vehicle speed to output the vehicle speed to the handheld device 200.

Another control result is that the vehicle parts X and Y or the vehicle parts controller 110 reject receiving the control request, and rejection reasons include that a related function is locked, the vehicle lacks corresponding vehicle parts X and Y, and an Vehicle model does not match a current vehicle. In this case, the control result is a message about a control failure, and is returned to the handheld device 200.

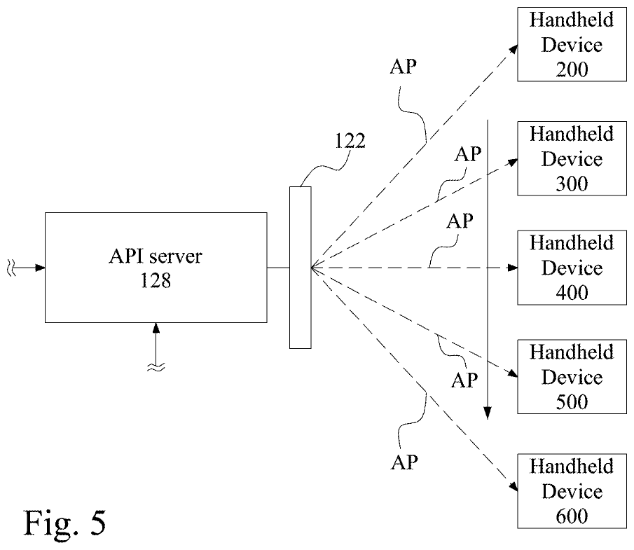

As shown in FIG. 5, a specific manner in which the API 122 receives the command package includes actively making a query. The API 122 periodically sends a query signal to scan the handheld device 200, and continuously handshakes with the handheld device 200 to maintain a pairing connection state. If no command package needs to be sent, the handheld device 200 merely returns an identifier, an authorization code, and a handshake command. If the command package needs to be sent, the handheld device 200 returns an identifier, an authorization code, and a command package.

When multiple handheld devices 200 have been paired with the API 122, for example, there are multiple members on the vehicle and the handheld devices 200, 300, 400, 500, and 600 of each person have been paired with the API 122, the API 122 establishes multiple application communication channels AP by using multiple pairing procedures. The multiple handheld devices 200, 300, 400, 500, and 600 are in paired connections. In this case, the API 122 sequentially sends a query signal to the application communication channels AP periodically, to perform scanning, to receive multiple command packages from the multiple handheld devices 200, 300, 400, 500, and 600. The API 122 identifies, according to a receiving order of the command packages, whether the command packages match the service request and the control request. The command packages are identified according to the receiving order, to confirm and sequentially execute the content of the service request or the control request. If the command packages are controlled by the same application services A, B, C, and D or vehicle parts X and Y, the old request is replaced with the latest request. Certainly, different handheld devices 200, 300, 400, 500, and 600 may also be set with different privileges, so that each of the handheld devices 200, 300, 400, 500, and 600 can be related to different application services A, B, C, and D and vehicle parts X and Y. For example, a service application related to the hands-free mode of the mobile phone can be used only by a handheld device 200 of the vehicle driver. For another example, for the safety of driving, detailed settings, such as audio setting, of the vehicle parts X and Y cannot be used by the handheld device 200 of the vehicle driver.

In the present disclosure, by means of a connection between the API server 128 and the control request transmitter 124, a technical problem that the handheld device 200 cannot be connected to vehicle parts X and Y of a vehicle is resolved, so that the handheld device 200 can more widely communicate with the vehicle to increase application manners of the handheld device 200.

What is claimed is:

1. An on-board information system of an on-board unit, comprising:
a vehicle parts controller, configured for receiving a control request for a parts control operation; and
an on-board unit, comprising:
an application programming interface, configured for establishing an application communication channel via a pairing procedure, and receiving a command package via the application communication channel;
a control request transmitter, configured for establishing communication with the vehicle parts controller;
an application executing module, providing an application service, wherein the application service is in response to at least one service request; and
an application programming interface server, configured for receiving the command package via the application programming interface, and comparing the command package with the service request;
wherein when the command package matches the service request, the application programming interface server drives, according to the service request, the application executing module to execute the application service, and provides the application service via the application communication channel;
wherein when the command package does not match the service request, the application programming interface server compares the command package with the control request; and
when the command package matches the control request, the application programming interface server transmits the control request to the vehicle parts controller for executing the parts control operation according to the control request.

2. The on-board information system of an on-board unit according to claim 1, wherein the application service is for sending an information request of specified information via the application communication channel, receiving a response with regard to the specified information via the application communication channel, and displaying the specified information.

3. The on-board information system of an on-board unit according to claim 2, wherein the application service regularly and repeatedly sends the information request, and receives the response with regard to the specified information, to update the displayed specified information.

4. The on-board information system of an on-board unit according to claim 1, wherein the application service is for sending a handheld device control request via the application communication channel, and receiving a handheld device control response via the application communication channel.

5. The on-board information system of an on-board unit according to claim 1, wherein the vehicle parts controller returns a control result after executing the part control operation and the application programming interface server receives the control result, and outputs the control result via the application communication channel.

6. The on-board information system of an on-board unit according to claim 5, wherein the parts control operation comprises detecting a parts operation status as the control result.

7. The on-board information system of an on-board unit according to 1, wherein the application programming interface establishes multiple application communication channels via multiple pairing procedures, scans the application communication channels sequentially to receive multiple command packages, and compares, according to a receiving order of the command packages, with the service request.

8. A method for data processing of an on-board-unit, comprising:
establishing an application communication channel via a pairing procedure;
establishing communication with a vehicle parts controller, wherein the vehicle parts controller is configured for receiving a control request for a parts control operation;
enabling at least one application service in response to a service request;
receiving a command package, and comparing the command package with the service request;
when the command package matches the service request, providing the application service via the application communication channel;
when the command package does not match the service request, comparing the command package with the control request; and
when the command package matches the control request, transmitting the control request to the vehicle parts controller for executing the parts control operation according to the control request.

9. The method for data processing of an on-board-unit according to claim 8, wherein the step of providing the application service comprises:
sending an information request of specified information via the application communication channel, and receiving a response with regard to the specified information via the application communication channel, to display the specified information.

10. The method for data processing of an on-board-unit according to claim 9, wherein the step of providing the application service comprises:
regularly and repeatedly sending the information request, and receiving the response with regard to the specified information, to update the displayed specified information.

11. The method for data processing of an on-board-unit according to claim 8, wherein the step of providing the application service comprises:
sending a handheld device control request via the application communication channel, and receiving a handheld device control response via the application communication channel.

12. The method for data processing of an on-board-unit according to claim 8, further comprising:
returning a control result after executing the parts control operation, and outputting the control result via the application communication channel.

13. The method for data processing of an on-board-unit according to claim 12, wherein the parts control operation comprises detecting a parts operation status as the control result.

14. The method for data processing of an on-board-unit according to claim 8, further comprising:
establishing multiple application communication channels via multiple pairing procedures;
scanning the application communication channels sequentially to receive multiple command packages; and
comparing, according to a receiving order of the command packages, whether the command packages match the service request.
